(19) United States
(12) Patent Application Publication
(10) Pub. No.: US 2025/0030278 A1
(43) Pub. Date: Jan. 23, 2025

(54) WIRELESS CHARGING CONFIGURATION

(71) Applicant: INTERNATIONAL BUSINESS MACHINES CORPORATION, ARMONK, NY (US)

(72) Inventors: Su Liu, Austin, TX (US); Jeremy R. Fox, Georgetown, TX (US); Tushar Agrawal, West Fargo, ND (US); Zachary A. Silverstein, Georgetown, TX (US)

(21) Appl. No.: 18/355,511

(22) Filed: Jul. 20, 2023

(51) Int. Cl. H02J 50/90; H02J 50/20; H02J 50/40

(52) U.S. Cl. CPC H02J 50/90; H02J 50/20; H02J 50/40

(57) ABSTRACT

Described is a method for an augmented Quality of Service (QoS) wireless charging configuration in an Internet of Things (IoT) network for managing wireless charging of devices within an area. The method can identify multiple wirelessly chargeable devices within an area and generate a spatial plan for the area with the multiple wirelessly chargeable devices. The method can further identify a position for each wirelessly chargeable device devices within the spatial plan for the area and determine priority for the identified wirelessly chargeable devices based on status information for each wirelessly chargeable device. The method can adjust a wireless charging signal pattern for the spatial plan based on the priority for the identified wirelessly chargeable devices.

### BACKGROUND

This disclosure relates generally to wireless charging, and in particular to Quality of Service (QoS) based wireless charging configuration.

Wireless charging is commonly known to utilize electromagnetic induction to provide electricity to via wireless power transfer between a power source and a battery of an electronic device that supports inductive charging. However, emerging technology provides wireless charging utilizing an infrared (IR) signal or a radio frequency (RF) signal to send an electric charge over the air to a receiving electronic device. The IR signal is a line-of-sight solution that requires sending sensors on a power source and receiving sensors on an electronic device to be unobstructed. A transmitter at the power source converts electricity into a light beam and the receiver on the electronic device converts the light beam back to electricity, which can be utilized to charge the battery of the electronic device. Wireless charging utilizing IR signals can charge electronic devices located in a vicinity of the transmitter, such as, a meeting room in an office building or a lounge in an airport. Wireless charging utilizing RF signals allows for an electronic device to be in a vicinity to receive a charge without requiring a line of sight to the RF signal transmitter. IR signals and RF signals are just a couple of examples of wireless based charging signals, where other examples of wireless charging methods include magnetic induction, magnetic resonance, ultrasound charging, and laser charging.

With the introduction of technology to wirelessly charge electronic devices, there is currently an absence for managing the Quality of Service (QoS) for wireless charging of devices within a given space. The QoS is a measurement of overall performance of a service, where the performance is typically seen by the user of a network receiving the service. The QoS with respect to wirelessly charging devices utilizing wireless charging signals includes an ability to manage the charging of the wirelessly chargeable devices. Specifically, when there is a large quality of wirelessly chargeable devices present within an area with limited wireless charging signal producers for the IR signals or RF signals to charge each of the wirelessly chargeable devices.

### SUMMARY

Embodiments in accordance with the present invention disclose a method, computer program product and computer system for Quality of Service based wireless charging configuration, the method, computer program product and computer system can identify a plurality of wirelessly chargeable devices within an area. The method, computer program product and computer system can generate a spatial plan for the area with the plurality of wirelessly chargeable devices. The method, computer program product and computer system can identify a position for each wirelessly chargeable device from the plurality of chargeable devices within the spatial plan for the area. The method, computer program product and computer system can determine priority for the plurality of wirelessly chargeable devices based on status information for each wirelessly chargeable device from the plurality of chargeable devices. The method, computer program product and computer system can adjust a wireless charging signal pattern for the spatial plan based on the priority for the plurality of wirelessly chargeable devices. An advantage includes utilizing status information for identified wirelessly chargeable devices within an area to determine priority and adjusting the wireless charging signal pattern providing the wireless charging signal based the priority for charging needs.

Other embodiments in accordance with the present invention disclose a method, computer program product and computer system for Quality of Service based wireless charging configuration, the method, computer program product and computer system can generate an augmented configuration interface for the wireless charging signal pattern for the spatial plan, wherein the augmented configuration interface allows a user to alter the priority for the plurality of wirelessly chargeable devices. An advantage includes a visual representation via the augmented configuration interface to manage priority for charging the plurality of wirelessly chargeable devices.

Other embodiments in accordance with the present invention disclose a method, computer program product and computer system for Quality of Service based wireless charging configuration, the method, computer program product and computer system can responsive to receiving, via the augmented configuration interface, a request from the user to alter the priority for the plurality of wirelessly chargeable devices, determine whether the user is authorized to alter the priority for the plurality of wirelessly chargeable devices. The method, computer program product and computer system can, responsive to determining the user is authorized to alter the priority for the plurality of wirelessly chargeable devices, provide, via the augmented configuration interface, control for the wireless charging signal pattern to the user. The method, computer program product and computer system can receive, via the augmented configuration interface, an alteration to the priority for the plurality of wirelessly chargeable devices. An advantage includes allowing for administrative and/or user to actively alter the wireless charging signal pattern and thus altering the priority of charging for the wirelessly chargeable devices based on administrative and/or user needs.

Other embodiments in accordance with the present invention disclose a method, computer program product and computer system for Quality of Service based wireless charging configuration, the method, computer program product and computer system can receive, via the augmented configuration interface, an input from the user altering a direction of the charge wireless charging signal pattern from a first location of a first wirelessly chargeable device from the plurality to a second location of a second wirelessly chargeable device, wherein altering the direction of the charge wireless charging signal pattern alters the priority for the first wirelessly chargeable device and the second wirelessly chargeable device. An advantage includes an augmented configuration interface for streamlined alterations to the wireless charging signal pattern without having to access a data structure to alter the priority for the wirelessly chargeable devices located within the area.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts components of a wireless charging configuration program for managing wireless charging of devices within an area, in accordance with an embodiment of the present invention.

FIG. 3 depicts an example flowchart for components of a wireless charging configuration program for managing wireless charging of devices within an area, in accordance with an embodiment of the present invention.

FIG. 4A depicts a process flow for a wireless charging configuration program for managing wireless charging of devices within an area, in accordance with an embodiment of the present invention.

FIG. 4B depicts a continuation of a flowchart for a wireless charging configuration program for managing wireless charging of devices within an area from FIG. 4A, in accordance with an embodiment of the present invention.

FIG. 5 depicts an example of data structure changes for a wireless charging configuration program for managing wireless charging of devices within an area, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

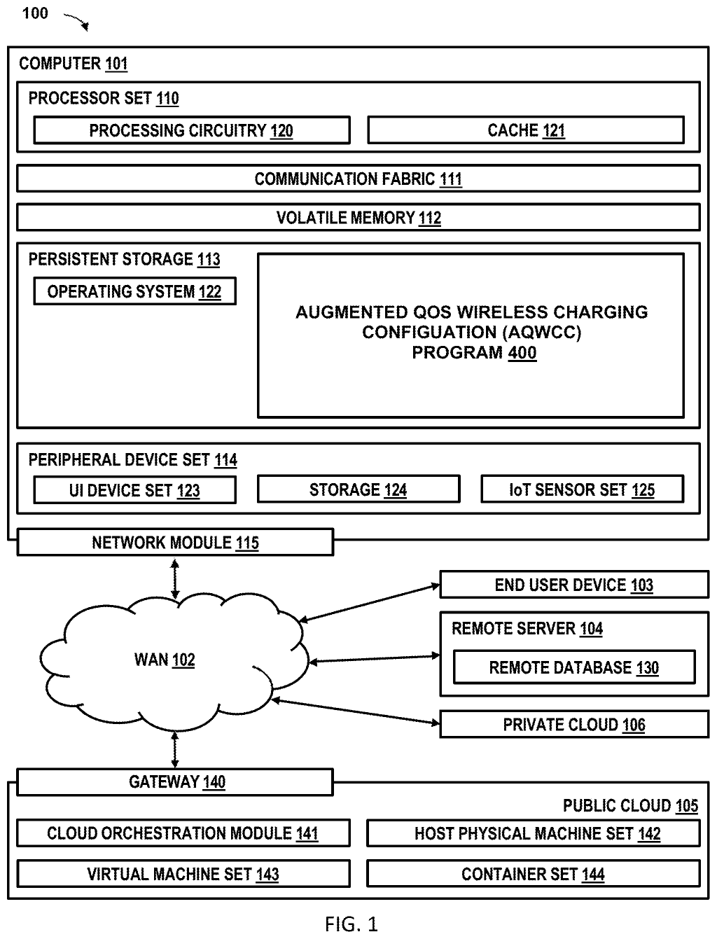

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, Augmented Quality of Service (QoS) Wireless Charging Configuration (AQWCC) program 400. In addition to block 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 400, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 400 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 400 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

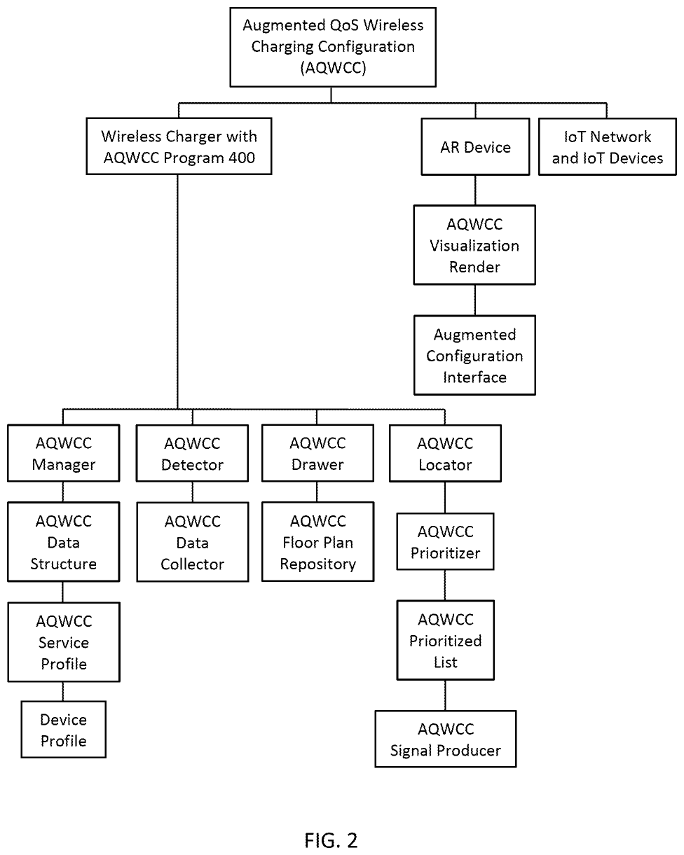

FIG. 2 depicts components of a wireless charging configuration program for managing wireless charging of devices within an area, in accordance with an embodiment of the present invention. In this embodiment, an augmented Quality of Service (QoS) wireless configuration (AQWCC) system utilizes a wireless charger component with AQWCC program 400 to manage wireless charging of Internet of Things (IoT) devices within a defined area (e.g., airport terminal gate, office conference room). The AQWCC system includes an IoT network for connecting the IoT devices within the area to wireless charger with AQWCC program 400 and an AR device for displaying an augmented configuration interface for a wireless charging signal pattern within the area by AQWCC program 400. AQWCC program 400 wireless charges the IoT devices utilizing wireless charging signals to send a charge over the air to each of the receiving devices. Though in this embodiment AQWCC program 400 charges IoT devices and communicates to the IoT devices over the IoT network to adjust priority, AQWCC program 400 can charge non-IoT devices depending on wireless charging signal availability at the location.

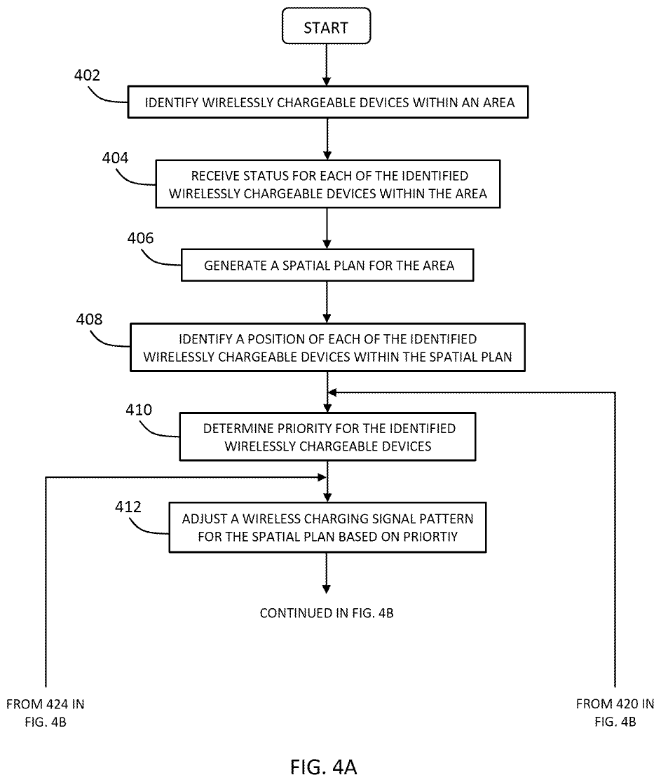

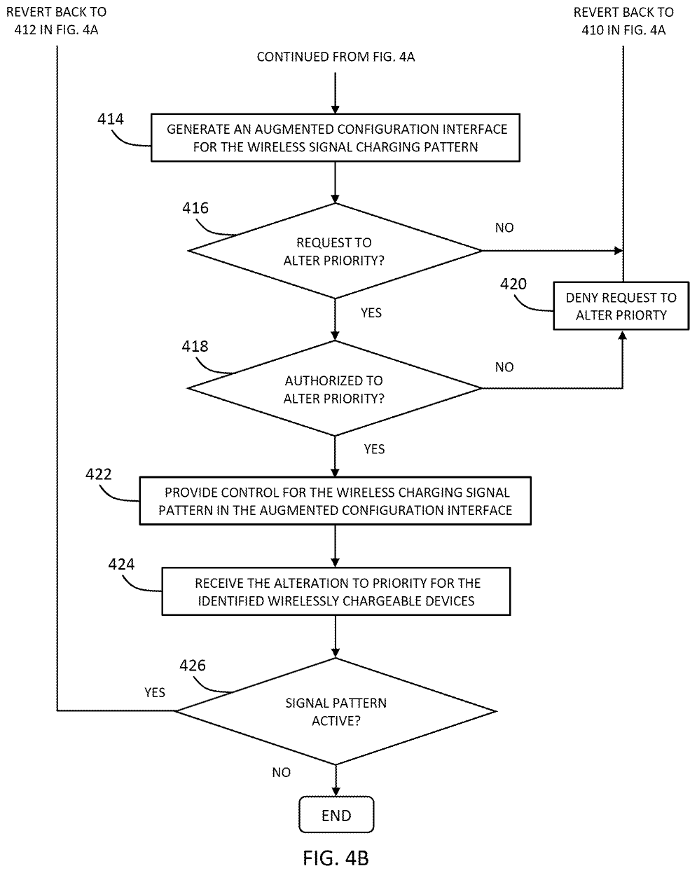

Wireless charger with AQWCC program 400 can include an AQWCC manager component, an AQWCC detector component, an AQWCC drawer component, and an AQWCC locator component for performing the method of AQWCC program 400 discussed in detail with regards to FIG. 4A and 4B. The AQWCC manager includes AQWCC data structure, an AQWCC service profile, and a device profile component. AQWCC program 400 utilizes the AQWCC manager component to define the AQWCC data structure to track and save a current QoS status for each of the IoT devices. The AQWCC data structure can include items such as, a floorplan ID, a wireless signal charger ID, a chargeable device list, a location for each chargeable device within the defined area, and defined prioritization). The AQWCC manager component also utilizes the AQWCC service profile and the device profile for the wireless signal chargers to determine a priority for the chargeable devices on the chargeable device list.

AQWCC program 400 utilizes an AQWCC detector component to detect chargeable devices within the defined area to create the chargeable device list, where an AQWCC data collector component of AQWCC detector component receives status information from each of the detected chargeable devices with the defined area. AQWCC program 400 utilizes an AQWCC drawer component to draw a spatial plan (2-dimensional and/or 3-dimensional) for the area with the rechargeable devices and stores the spatial plan for the area in the AQWCC floor plan repository. AQWCC program 400 utilizes an AQWCC locator component to identify and track a relative position (e.g., x, y, z position) for each chargeable device within the spatial plan for the area. AQWCC program 400 utilizes the AQWCC prioritizer to determine an order for charging the chargeable devices with the wireless charging signal based on the status (e.g., charge level, priority level) for each of the chargeable devices within the spatial plan for the area and generates the AQWCC prioritized list with the determined order. AQWCC program 400 utilizes the AQWCC signal producer to adjust a wireless charging signal pattern for the area based on the AQWCC prioritized list and the relative position for each of the chargeable devices identified and tracked by the AQWCC locator. AQWCC program 400 allows for an authorized user to adjust the wireless charging signal pattern utilizing the AR device. An AQWCC visualization render can display a current wireless charging signal pattern in an augmented configuration interface in the AR device for the area with the chargeable devices and the authorized user can adjust the QoS priorities for the chargeable device in the augmented configuration interface.

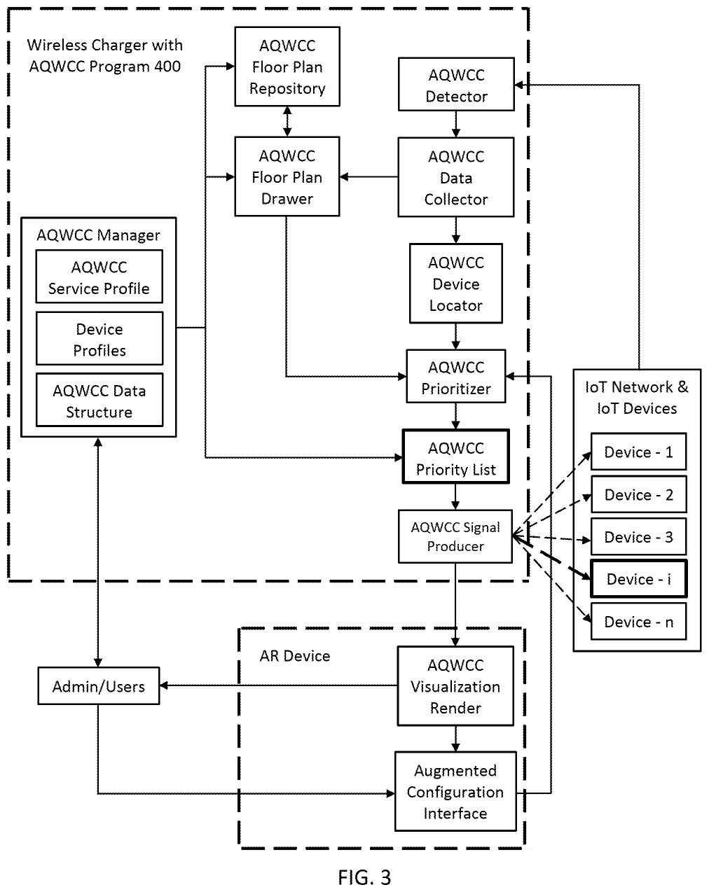

FIG. 3 depicts an example process flow for components of a wireless charging configuration program for managing wireless charging of devices within an area, in accordance with an embodiment of the present invention. As previously discussed with regards to FIG. 2. the augmented QoS wireless configuration (AQWCC) system utilizes a wireless charger component with AQWCC program 400 to manage wireless charging of rechargeable IoT devices within a defined area. The AQWCC system includes an IoT network for connecting the IoT devices within the area to wireless charger with AQWCC program 400 and an AR device for displaying an augmented configuration interface for a wireless charging signal pattern within the area by AQWCC program 400. AQWCC program 400 includes AQWCC manager with an AQWCC service profile, a device profile component, and AQWCC data structure. AQWCC program 400 utilizes the AQWCC manager component to define the AQWCC data structure to track and save a current QoS status for each of Device-1, Device-2, Device-3, Device-i, and Device-n. The AQWCC data structure can include items such as, a floorplan ID, a wireless signal charger ID, a chargeable device list, a location for each chargeable device within the defined area, and defined prioritization). In this embodiment, AQWCC program 400 identifies wirelessly chargeable devices within an area represented by Device-1, Device-2, Device-3, Device-i, and Device-n utilizing the AQWCC detector, where Device-n represents a final numbered (e.g., 10^{th}) wirelessly chargeable device within the area. AQWCC program 400 receives status for Device-1, Device-2, Device-3, Device-i, and Device-n utilizing the AQWCC data collector that can include a state of charge, a level of privacy setting, a user defined desired state of charge, and a device manufacturer defined state of charge.

AQWCC program 400 generates a spatial plan for the area utilizing the AQWC floor plan drawer and stores the spatial plan for the area in the AQWCC floor plan repository for subsequent utilization. AQWCC program 400 identifies a position of Device-1, Device-2, Device-3, Device-i, and Device-n within the spatial plan utilizing AQWCC device locator. AQWCC program 400 can define a perimeter and any obstructions for the floorplan in terms of x, y, z coordinates and place each of Device-1, Device-2, Device-3, Device-i, and Device-n within the spatial plan with a set of x, y, z coordinates for the wirelessly chargeable devices. AQWCC program 400 determines a priority for charging the Device-1, Device-2, Device-3, Device-i, and Device-n utilizing the AQWCC prioritizer and generates the AQWCC priority list for charging the wirelessly chargeable devices. AQWCC program 400 continuously updates the AQWCC priority list as wirelessly chargeable devices enter and leave the spatial plan, and when the status for each of the wirelessly chargeable device's changes, since a first wirelessly chargeable device (e.g., Device-3) may not hold a charge as well as a second wirelessly chargeable device (e.g., Device-i). AQWCC program 400 adjusts a wireless charging signal pattern for the spatial based on AQWCC priority list utilizing AQWCC signal producer. In this embodiment, AQWCC program 400 generates an AQWCC priority list that indicates Device-i has the highest priority with respect to Device-1, Device-2, Device-3, and Device-n.

AQWCC program 400 generates an augmented configuration interface for the wireless charging signal pattern utilizing the AQWCC visualization render, where the augmented configuration interface provides a visualization of each Device-1, Device-2, Device-3, and Device-n within the spatial plan of the area that an administrator and/or user is positioned. An administrator can represent a person managing AQWCC program 400 for the various wirelessly chargeable devices within the area and a user represents a person with a device (e.g., Device-1) requiring wireless charging by AQWCC program 400 within the area. If AQWCC program 400 determines the administrator and/or user is authorized to alter the AQWCC priority list, AQWCC program 400 displays the visualization in the AR device associated with the administrator and/or user, where the augmented configuration interface allows for the administer and/or user to request an alteration to the AQWCC priority list. AQWCC program 400 receives the alteration to the AQWCC priority list for the wireless charging signal pattern and instructs the AQWCC signal producer to alter the wireless charging signal pattern based on the alteration to the AQWCC priority list.

FIG. 4A depicts a flowchart for a wireless charging configuration program for managing wireless charging of devices within an area, in accordance with an embodiment of the present invention.

AQWCC program 400 identifies wirelessly chargeable devices within an area (402). Wirelessly chargeable devices represent electronic devices capable of receiving electrical charge through a wireless charging signal, where the wirelessly chargeable devices can store the received electrical charge in a battery or capacitor. Alternatively, the wirelessly chargeable device can utilize the received electrical charge for active power without storing the received electrical charge. AQWCC program 400 can identify the wirelessly chargeable devices within an area by sending a query over a local network (e.g., Wi-Fi) providing a communications network to identify which of the devices can accept a wireless charging signal to receive the electrical charge. Alternatively, AQWCC program 400 can send a wider network (e.g., cellular network) providing the communication network to identify which of the device can accept the wireless charging signal to receive the electrical charge. In one example, AQWCC program 400 identifies wirelessly chargeable devices within an office conference room. AQWCC program 400 utilizes a local network to identify which devices are within the area of the office conference room (e.g., Wi-Fi triangulation) and which of the identified devices are wirelessly chargeable devices capable of accepting the wireless charging signal.

In another example, AQWCC program 400 identifies wirelessly chargeable devices within a gate waiting area at an airport terminal. AQWCC program 400 utilizes a combination of a local Wi-Fi network and a wider cellular network to identify the devices present within the gate waiting area at the airport terminal and identifies which of the identified devices are wirelessly chargeable devices. AQWCC program 400 can utilizes metadata associated with each of the identified devices within the area to identify a portion of the devices that are wirelessly chargeable devices (e.g., cellphone, tablet computer) and a portion of the devices that are not wirelessly chargeable devices (e.g., office printer, smart television). Additionally, AQWCC program 400 identifies a portion of the devices that are currently not being charged and a remaining portion of the devices that are currently being charged. AQWCC program 400 removes the remaining portion of the devices from being included in the identified wirelessly chargeable devices within the area, since those devices can experience overcharging and can potentially lead to a battery thermal event.

AQWCC program 400 receives status for each of the identified wirelessly chargeable devices within the area (404). AQWCC program 400 queries each of the identifies wirelessly chargeable devices within the area to receive status information. The status information can include a state of charge, a level of privacy setting, a user defined desired state of charge, and a device manufacturer defined state of charge. The state of charge for the wirelessly chargeable device represents a remaining battery charge until depletion, such as, a battery percentage or an amount of battery left to power the wirelessly chargeable device. The level of privacy setting indicates whether an owner of the wirelessly chargeable device allows or prevents AQWCC program 400 from charging the wirelessly chargeable device utilizing the wireless charging signal. The user defined desired state of charge represents an amount of charge the owner of the wirelessly chargeable device desires, such as, a 75% level of battery or 3 hours of battery left. A device manufacturer defined state of charge can represent a manufacturer defined maximum charge level (e.g., 80% battery level) to prevent battery degradation or a maximum charge level as provided by the owner to an operating system managing the charge level of the wirelessly chargeable device. In some embodiments, AQWCC program 400 can receive a status from a wirelessly chargeable device indicating an active fault with an ability to receive an electrical charge from wireless charging signal. AQWCC program 400 can exclude the wirelessly chargeable device from a priority list for providing charge via the wireless charging signal, discussed in further detail with regards to (410), to prevent damage due to the active fault (e.g., battery thermal event).

AQWCC program 400 generates a spatial plan for the area (406). In one embodiment, AQWCC program 400 utilizes the wireless charging signal for wirelessly charging devices to generate a 2-dimensional and/or 3-dimensional spatial plan for the area in which AQWCC program 400 operates the AQWCC signal producer. AQWCC program 400 can instruct an AQWCC signal producer to emit a wireless charging signal and capture a reflection of the wireless charging signals by one or more cameras capable of capturing the wireless charging signal. The reflections of the wireless charging signal are due to obstructions within the area, such as, walls, ceilings, stairs, pillars, windows, tables, chairs, persons, and any other matter occupying space within the area. AQWCC program 400 generates the spatial plan for the area for a particular point in time, where certain temporary obstructions are present in one instance of the generated spatial plan and are not present in another instance of the generated spatial plan for the same area. AQWCC program 400 can also compare instances of multiple spatial plans for the area to determine which obstructions are permanent (e.g., walls, pillars) and which obstructions are temporary (e.g., persons, chairs) and AQWCC program 400 can generate a base spatial plan for the area. In another embodiment, AQWCC program 400 receives blueprints for the area in which AQWCC program 400 operates the AQWCC signal producer and based on the received blueprints, AQWCC program 400 generates the spatial plan for the area. In yet another embodiment, AQWCC program 400 utilizes laser imaging, detection, and ranging (Lidar) to perform a laser scan of the area within which the AQWCC program 400 operates the AQWCC signal producer.

AQWCC program 400 identifies a position of each of the identified wirelessly chargeable devices within the spatial plan (408). In one embodiment, AQWCC program 400 identifies a position of each of the identified wirelessly chargeable devices within the spatial plan utilizing the AQWCC signal producer to ping each device to determine an x, y, z position within the spatial plan for the area. In another embodiment, AQWCC program 400 utilizes a local communication network (e.g., Wi-Fi) to which each of the wirelessly chargeable devices are connected to identify a position of each of the identified wirelessly chargeable devices within the spatial plan for the area. A local communication network positioning system, such as, a Wi-Fi positioning system (WPS) utilizes characterizes of nearby Wi-Fi hotspots and various other wireless based access point to identify a position of an electronic device within the spatial plan for the area. In one example, AQWCC program 400 generates a spatial plan for an office conference room that includes various walls, pillars, windows, ceiling, a large desk, and multiple chairs. AQWCC program 400 identifies a position of each of the identified wirelessly chargeable device within the office conference room utilizing WPS for the local Wi-Fi network to which each of the wirelessly chargeable device can connect to. In one example, AQWCC program 400 generates a spatial plan for an airport gate waiting area that includes various walls, pillars, windows, ceiling, and multiple chairs. AQWCC program 400 identifies a position of each of the identified wirelessly chargeable device within the airport gate waiting area utilizing the AQWCC signal producer to ping each device to determine a position with respect to the generated spatial plan for the area.

AQWCC program 400 determines priority for the identified wirelessly chargeable devices (410). AQWCC program 400 utilizes status information for each of the identified wirelessly chargeable devices, an amount of identified wirelessly chargeable devices (e.g., twenty), and/or AQWCC signal producer availability (e.g., four for the area defined by the spatial plan) to determine priority for charging each of the wirelessly chargeable device and generates a priority list. As previously discussed, the status information can include a state of charge, a level of privacy setting, a user defined desired state of charge, and a device manufacturer defined state of charge. AQWCC program 400 can also utilize base rules for determining priority for the wirelessly chargeable device. An example of a base rule can define a maximum charge level (e.g., 80%) or maximum charge time (e.g., 20 minutes) for a wirelessly chargeable device based on an amount of identified wirelessly chargeable devices within the spatial plan for the area and AQWCC signal producer availability. Another example of a base rule can define device type priority, where a smartphone wireless rechargeable device can have higher priority over a smartwatch wireless rechargeable device and a tablet computer wireless rechargeable device can have higher priority over a smartphone wireless rechargeable device.

In one example, there are twenty identified wirelessly chargeable devices within a spatial plan and four AQWCC signal producers to provide electrical charge. AQWCC program 400 utilizes the status information for each of the twenty identified wirelessly chargeable devices to prioritize the devices with lowest charge level first, where AQWCC program 400 determines an identified wirelessly chargeable device with the lowest charge level has the highest priority and an identified wirelessly chargeable device with the highest charge level has the lower priority. Due to limited AQWCC signal producer availability for the twenty device, AQWCC program 400 charges each device to 80% of a maximum charge level before moving onto the next identified wirelessly chargeable device on the priority list. Since a typical battery charges at a quicker rate when the battery level is lowest and tappers off once the battery level approaches a maximum charge, AQWCC program 400 optimizes the charging of the identified wirelessly chargeable devices when a limited amount of AQWCC signal producers are available. In another example, there are ten identified wirelessly chargeable devices within a spatial plan and two AQWCC signal producers to provide electrical charge. AQWCC program 400 utilizes a device type for each of the. Ten identified wirelessly chargeable devices to create two priority lists, a first priority list directed to non-wearable devices (e.g., smartphone, table computer) and a second priority list directed to wearable devices (e.g., smartwatch, headsets). For the two priority lists, AQWCC program 400 utilizes the status information for each of the ten identified wirelessly chargeable devices to prioritize the devices with lowest charge level first, where AQWCC program 400 determines an identified wirelessly chargeable device with the lowest charge level has the highest priority and an identified wirelessly chargeable device with the highest charge level has the lower priority. Furthermore, AQWCC program 400 prioritizes the first priority list over the second priority, where AQWCC program 400 charges the devices on the second priority list after charging the devices on the first priority list.

In some embodiments, AQWCC program 400 utilizes an expected state of charge to further determine priority for each of the identified wirelessly chargeable device. The expected state of charge is based on an itinerary that represents an amount of battery level required for a specified amount of time as defined by the itinerary for an owner associated with the wirelessly chargeable device. In one example, there are twenty identified wirelessly chargeable devices within an office conference room and three AQWCC signal producer to provide electrical charge. AQWCC program 400 determines based on status information for one of the twenty identified wirelessly chargeable devices, a table computer within the office conference room indicates a 10% level of charge for the battery and an expected remaining battery of 25 minutes. AQWCC program 400 also determines an expected state of charge of one hour for the table computer based on a calendar entry (i.e., itinerary) for a meeting lasting one hour. AQWCC program 400 can priority the tablet computer with the expected state of charge over another wirelessly chargeable device (e.g., smartphone) with a lower level of charge (e.g., 5% battery level) that does not have an expected level of charge.

In another example, there are eighty identified wirelessly chargeable devices within an airport gate waiting area and ten AQWCC signal producers to provide electrical charge. AQWCC program 400 determines an expected state of charge of three hours for the identified wireless charging devices at the airport gate waiting area based on flight information associated with the airport gate waiting area, wherein the flight information indicates a three-hour flight between current location A and destination location B. AQWCC program 400 determines a priority for the eighty identified wirelessly chargeable devices based on the status information and the expected state of charge of three hours. If a first device with a higher battery percentage level (e.g., 60%) has only 2 and a half hours of battery remaining compared to a second device with a lower battery percentage level (e.g., 50%) having 3 and a half hours of battery remaining, AQWCC program 400 priorities the first device over the second device. AQWCC program 400 can charge, with the AQWCC signal producer, the first device until the 3 hours of battery remaining amount is reached and then can charge the subsequent device on the priority list.

AQWCC program 400 adjusts a wireless charging signal pattern for the spatial plan based on priority (412). In this embodiment, AQWCC program 400 adjusts a wireless charging signal pattern for the spatial plan based on priority by instructing an AQWCC signal producer to charge a device utilizing wireless charging signals. Based on the identified position of each of the identified wirelessly chargeable device within the spatial plan, AQWCC program 400 instructs each of the available AQWCC signal producers to charge each wirelessly chargeable device in an order according to the priority list to a battery level. As previously discussed, the battery level can be defined by a base rule, a device manufacturer battery level, and/or to an administrator and/or user defined battery level. If a wirelessly chargeable device is within the spatial plan for the area but is non-stationary, AQWCC program 400 instructs the AQWCC signal producer to move and follow the wirelessly chargeable device as the position changes. Instructing can include AQWCC program 400 controlling one or more mechanism on the AQWCC signal producer to position the AQWCC signal producer to project the wireless charging signal toward the wirelessly chargeable device and provide the electrical charge. If the wirelessly chargeable device leaves the spatial plan for the area, AQWCC program 400 removes the wirelessly chargeable device from the priority list and instructs the AQWCC signal producer to direct the wireless charging signal toward the next wirelessly chargeable device on the priority list. If a battery level for a wirelessly chargeable device reaches a base rule, a device manufacturer battery level, or to an administrator and/or user defined battery level, AQWCC program 400 instructs the AQWCC signal producer to reposition to send a signal to the next wirelessly chargeable device on the priority list.

FIG. 4B depicts a continuation of a flowchart for a wireless charging configuration program for managing wireless charging of devices within an area from FIG. 4A, in accordance with an embodiment of the present invention.

AQWCC program 400 generates an augmented configuration interface for the wireless charging signal pattern (414). AQWCC program 400 generates an augmented configuration interface for the wireless charging signal pattern for displaying in an augmented reality (AR) device associated with an administrator and/or user. As previously discussed, an administrator can represent a person managing AQWCC program 400 for the various wirelessly chargeable devices within the area and a user represents a person with a device requiring wireless charging by AQWCC program 400 within the area. The augmented configuration interface includes an identification marker for each of the identified wirelessly chargeable device and highlights boundaries defined by the spatial plan for the area in which AQWCC program 400 operates. AQWCC program 400 can also indicate in the augmented configuration interface a location of each AQWCC signal producer, a wireless charging signal path for each AQWCC signal producer when directed to a wirelessly chargeable device from the priority list, and which of the AQWCC signal producers are active and inactive. AQWCC program 400 indicating which of the AQWCC signal producers are active and inactive in the augmented configuration interface allows for a person with a wirelessly chargeable device to relocate to a subarea to active the AQWCC signal producer to charge the device. Alternatively, AQWCC program 400 indicating which of the AQWCC signal producers are active and inactive in the augmented configuration interface allows for the administrator to send a message to one or more wirelessly chargeable devices currently awaiting to receive charge based on the priority list that relocating to the subarea with the inactive AQWCC signal producer can result an immediate charge being provided to the device, bypassing the priority list.

AQWCC program 400 determines whether there is a request to alter priority for the wireless charging signal pattern (decision 416). In the event AQWCC program 400 determines there is a request to alter priority for the wireless charging signal pattern (“yes” branch, decision 416), AQWCC program 400 determines whether the user is authorized to alter priority for the wireless charging signal pattern (decision 418). In the event AQWCC program 400 determines there is no request to alter priority for the wireless charging signal pattern (“no” branch, decision 416), AQWCC program 400 reverts to (410) in FIG. 4A to determine priority for the identified wirelessly chargeable devices.

AQWCC program 400 whether the user is authorized to alter priority for the wireless charging signal pattern (decision 418). In the event AQWCC program 400 determines the user is authorized to alter priority for the wireless charging signal pattern (“yes” branch, decision 418), AQWCC program 400 provides control for the wireless charging signal pattern in the augmented configuration interface (422). In the event AQWCC program 400 determines the user is not authorized to alter priority for the wireless charging signal pattern (“no” branch, decision 418), AQWCC program 400 denies the request to alter priority (420) and reverts to (410) in FIG. 4A to determine priority for the identified wirelessly chargeable devices. In some embodiments, an administrator of AQWCC program 400 performs the alteration to the priority list and AQWCC program 400 can bypass this authorization due to the administrator already having authorized access and control over the AQWCC signal producers for charging the wirelessly chargeable devices within the spatial plan of the area.

AQWCC program 400 provides control for the wireless charging signal pattern in the augmented configuration interface (422). In this embodiment, AQWCC program 400 provides control, in an AR device, for the wireless charging signal pattern for each AQWCC signal producer in the augmented configuration interface, where AQWCC program 400 display a position of each wireless charging signal pattern with respect to a current position of the administrator and/or user within the spatial plan for the area. In another embodiment, AQWCC program 400 provides control, in another device associated with administrator and/or user, for the wireless charging signal pattern for each AQWCC signal producer in the augmented configuration interface, where AQWCC program 400 display a position of each wireless charging signal pattern with respect to a current position of the administrator and/or user within the spatial plan for the area. As previously discussed, AQWCC program 400 indicates in the augmented configuration interface a location of each AQWCC signal producer, a wireless charging signal path for each AQWCC signal producer when directed to a wirelessly chargeable device from the priority list, and which of the AQWCC signal producers are active and inactive. However, as an authorized administrator and/or user, AQWCC program 400 allows for the user to interact and maneuver a wireless signal charging pattern for an AQWCC signal producer to another location within the spatial plan, thus alerting the priority for a wireless charging device.

AQWCC program 400 receives the alteration to priority for the identified wirelessly chargeable devices (424). In one embodiment, AQWCC program 400 receives the alteration to the priority for the wireless charging signal pattern by an administrator and/or user moving a wirelessly chargeable device from a first position to a second position on the priority list, where the second position is higher priority when compared to the first position for the wirelessly chargeable device. AQWCC program 400 can receives the alteration to priority list via an input on an AR device or another device associated with administrator and/or user. In another embodiment, AQWCC program 400 displays a visual for each of the AQWCC signal producer pattern in an AR device associated with administrator. AQWCC program 400 receives the alteration to priority for the wireless charging signal pattern via an input on the AR device, where the input moves a wireless charging signal pattern being produced by an AQWCC signal producer from a first location to a second location within the spatial plan for the area. The first location is associated with an identified position for a first wirelessly chargeable device and the second location is associated with an identified positioned for a second wirelessly chargeable device. Relocating the wireless charging signal pattern between the first location and the second location alters the priority for the first wirelessly chargeable device and the second wirelessly chargeable device, thus altering the priority list for the identified wirelessly chargeable device within the spatial plan for the area.

AQWCC program 400 determines whether the wireless charging signal pattern is active (decision 426). In the event AQWCC program 400 determines the wireless charging signal pattern is active (“yes” branch, decision 426), AQWCC program 400 reverts to (412) in FIG. 4A to adjust the wireless charging signal pattern for the spatial plan based on the alteration to priority. In the event AQWCC program 400 determines the wireless charging signal pattern is active (“yes” branch, decision 426), AQWCC program 400 determines ceases operations.

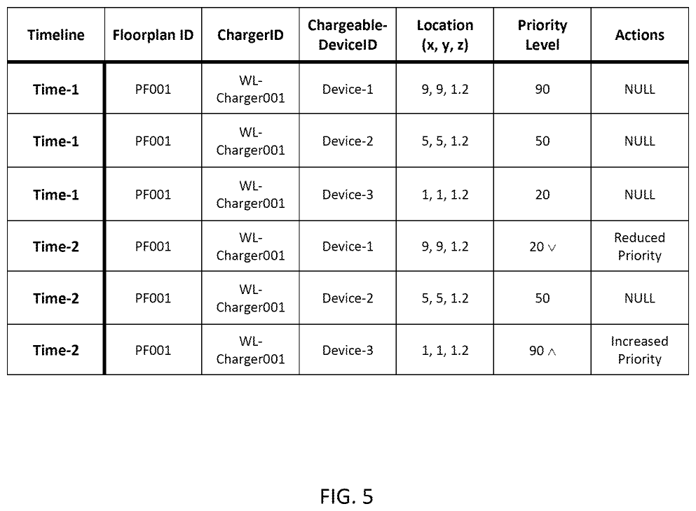

FIG. 5 depicts an example of data structure changes for a wireless charging configuration program for managing wireless charging of devices within an area, in accordance with an embodiment of the present invention. In this example, AQWCC program 400 identifies wirelessly chargeable devices Device-1, Device-2, and Device-3 within an area and stores each of the identified wirelessly chargeable devices as Chargeable-DeviceID in the AQWCC data structure. AQWCC program 400 receives status information for Device-1, Device-2, and Device-3 within the area, where Device-1 has a lower charge level than Device-2 and Device-2 has a lower charge level than Device-3. AQWCC program 400 generates spatial plan PF001 for the area within which Device-1, Device-2, and Device-3 reside and stores spatial plan PF001 as a Floor-PlanID in the AQWCC data structure. AQWCC program 400 identifies x, y, z coordinates for each of the wirelessly chargeable devices within spatial plan PF001, where Device-1 is positioned at (9, 9, 1.2) within spatial plan PF001, Device-2 is positioned at (5, 5, 1.2) within spatial plan PF001, and Device-3 is positioned at (1, 1, 1.2) within spatial plan PF001. AQWCC program 400 stores the x, y, z coordinates for each of the wirelessly chargeable devices within spatial plan PF001 as Location (x, y, z) in the AQWCC data structure.

AQWCC program 400 determines priority for Device-1, Device-2, and Device-3 with spatial plan PF001 based on the received status information for each of the wirelessly chargeable devices. In this example, AQWCC program 400 determines a priority level of 90 for Device-1, 50 for Device-2, and 20 for Device-3 at Time-1 and stores the Priority Level and Timeline in the AQWCC data structure. For spatial plan PF001, a single AQWCC signal producer designated WL-Charger001 provides the electrical charge to the wirelessly chargeable devices within the area based on the priority, where the WL-Charge001 is represented as the ChargerID in the AQWCC data structure. AQWCC program 400 adjust a wireless charging signal pattern of WL-Charger001 for spatial plan PF001 based on the priority level assigned to Device-1, Device-2, and Device-2, where AQWCC program 400 charges Device-1 first followed by Device-2 and Device-3. Since AQWCC program 400 determines the initial priority for Device-1, Device-2, and Device-3, the AQWCC data structures marks the actions as NULL since no alterations for priority are received from an administrator and/or user at Time-1 along the Timeline.

AQWCC program 400 generates an augmented configuration interface for the wireless charging signal pattern of WL-Charger001 in a device associated with the administrator and/or user and receives a request to alter the priority for the wirelessly chargeable devices. AQWCC program 400 determines the administrator and/or user has proper authorization to alter the priority and provides control for the wireless charging signal pattern in the augmented configuration interface for the wireless charging signal pattern of WL-Charger001. In one embodiment, AQWCC program 400 receives the alteration to the priority for the wireless charging signal pattern by viewing the priority list and swapping positions on the priority list for Device-1 and Device-3. In another embodiment, AQWCC program 400 receives the alternation to the priority by the administrator and/or user relocating the wireless charging signal pattern in the augmented configuration interface directed to location (9, 9, 1.2) for Device-1 to location (1, 1. 1.2) for Device-3. Additionally, AQWCC program 400 determines an owner of Device-1 is no longer actively using the device (i.e., display screen is off) and therefore, the priority to charge Device-1 is reduced lower than Device-2 and Device-3. For Time-2 along the Timeline, the new priority level for Device-1 is 20 and the new priority level for Device-3 is 90. AQWCC program 400 marks the actions as reduced priority for Device-1 and increased priority for Device-3, which actions for Device-2 are marked as NULL and a priority level remains unchanged.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying a plurality of wirelessly chargeable devices within an area;
generating a spatial plan for the area with the plurality of wirelessly chargeable devices;
identifying a position for each wirelessly chargeable device from the plurality of chargeable devices within the spatial plan for the area;
determining priority for the plurality of wirelessly chargeable devices based on status information for each wirelessly chargeable device from the plurality of chargeable devices; and
adjusting a wireless charging signal pattern for the spatial plan based on the priority for the plurality of wirelessly chargeable devices.

2. The computer-implemented method of claim 1, further comprising:
generating an augmented configuration interface for the wireless charging signal pattern for the spatial plan, wherein the augmented configuration interface allows a user to alter the priority for the plurality of wirelessly chargeable devices.

3. The computer-implemented method of claim 2, further comprising:
responsive to receiving, via the augmented configuration interface, a request from the user to alter the priority for the plurality of wirelessly chargeable devices, determining whether the user is authorized to alter the priority for the plurality of wirelessly chargeable devices;
responsive to determining the user is authorized to alter the priority for the plurality of wirelessly chargeable devices, providing, via the augmented configuration interface, control for the wireless charging signal pattern to the user; and
receiving, via the augmented configuration interface, an alteration to the priority for the plurality of wirelessly chargeable devices.

4. The computer-implemented method of claim 3, wherein receiving the alteration to the priority for the plurality of wirelessly chargeable devices further comprises:
receiving, via the augmented configuration interface, an input from the user altering a direction of the wireless charging signal pattern from a first location of a first wirelessly chargeable device from the plurality to a second location of a second wirelessly chargeable device, wherein altering the direction of the charge wireless charging signal pattern alters the priority for the first wirelessly chargeable device and the second wirelessly chargeable device.

5. The computer-implemented method of claim 3, wherein receiving the alteration to the priority for the plurality of wirelessly chargeable devices further comprises:
receiving, via the augmented configuration interface, an input from the user altering a position on a priority list of a first wirelessly chargeable device from the plurality of wirelessly chargeable device.

6. The computer-implemented method of claim 1, wherein the wireless charging signal pattern is selected from the group consisting of an infrared signal and a radio frequency signal, for charging each wirelessly chargeable device from the plurality of wirelessly chargeable devices.

7. The computer-implemented method of claim 1, further comprising:
receiving the status information for each wirelessly chargeable device from the plurality of chargeable devices, wherein the status information is selected from the group consisting of a state of charge, a level of privacy setting, a user defined desired state of charge, and a device manufacturer defined state of charge.

8. A computer program product comprising:
one or more computer-readable storage media;
program instructions, stored on at least one of the one or more storage media, to identify a plurality of wirelessly chargeable devices within an area;
program instructions, stored on at least one of the one or more storage media, to generate a spatial plan for the area with the plurality of wirelessly chargeable devices;
program instructions, stored on at least one of the one or more storage media, to identify a position for each wirelessly chargeable device from the plurality of chargeable devices within the spatial plan for the area;
program instructions, stored on at least one of the one or more storage media, to determine priority for the plurality of wirelessly chargeable devices based on status information for each wirelessly chargeable device from the plurality of chargeable devices; and
program instructions, stored on at least one of the one or more storage media, to adjust a wireless charging signal pattern for the spatial plan based on the priority for the plurality of wirelessly chargeable devices.

9. The computer program product of claim 8, further comprising:
program instructions, stored on at least one of the one or more storage media, to generate an augmented configuration interface for the wireless charging signal pattern for the spatial plan, wherein the augmented configuration interface allows a user to alter the priority for the plurality of wirelessly chargeable devices.

10. The computer program product of claim 9, further comprising:
program instructions, stored on at least one of the one or more storage media, responsive to receiving, via the augmented configuration interface, a request from the user to alter the priority for the plurality of wirelessly chargeable devices, determine whether the user is authorized to alter the priority for the plurality of wirelessly chargeable devices;
program instructions, stored on at least one of the one or more storage media, responsive to determining the user is authorized to alter the priority for the plurality of wirelessly chargeable devices, provide, via the augmented configuration interface, control for the wireless charging signal pattern to the user; and
program instructions, stored on at least one of the one or more storage media, to receive, via the augmented configuration interface, an alteration to the priority for the plurality of wirelessly chargeable devices.

11. The computer program product of claim 10, wherein program instructions, stored on at least one of the one or more storage media, to receive, via the augmented configuration interface, the alteration to the priority for the plurality of wirelessly chargeable devices, further comprises:
program instructions, stored on at least one of the one or more storage media, to receive via the augmented configuration interface, an input from the user altering a direction of the charge wireless charging signal pattern from a first location of a first wirelessly chargeable device from the plurality to a second location of a second wirelessly chargeable device, wherein altering the direction of the charge wireless charging signal pattern alters the priority for the first wirelessly chargeable device and the second wirelessly chargeable device.

12. The computer program product of claim 10, wherein program instructions, stored on at least one of the one or more storage media, to receive, via the augmented configuration interface, the alteration to the priority for the plurality of wirelessly chargeable devices, further comprises:
program instructions, stored on at least one of the one or more storage media, to receive, via the augmented configuration interface, an input from the user altering a position on a priority list of a first wirelessly chargeable device from the plurality of wirelessly chargeable device.

13. The computer program product of claim 8, wherein the wireless charging signal pattern is selected from the group consisting of an infrared signal and a radio frequency signal, for charging each wirelessly chargeable device from the plurality of wirelessly chargeable devices.

14. The computer program product of claim 8, further comprising:
program instructions, stored on at least one of the one or more storage media, to receive the status information for each wirelessly chargeable device from the plurality of chargeable devices, wherein the status information is selected from the group consisting of a state of charge, a level of privacy setting, a user defined desired state of charge, and a device manufacturer defined state of charge.

15. A computer system comprising:
one or more processors, one or more computer-readable memories and one or more computer-readable storage media;
program instructions, stored on at least one of the one or more storage media for execution by at least one of the one or more processors via at least one of the one or more memories, to identify a plurality of wirelessly chargeable devices within an area;
program instructions, stored on at least one of the one or more storage media for execution by at least one of the one or more processors via at least one of the one or more memories, to generate a spatial plan for the area with the plurality of wirelessly chargeable devices;
program instructions, stored on at least one of the one or more storage media for execution by at least one of the one or more processors via at least one of the one or more memories, to identify a position for each wirelessly chargeable device from the plurality of chargeable devices within the spatial plan for the area;
program instructions, stored on at least one of the one or more storage media for execution by at least one of the one or more processors via at least one of the one or more memories, to determine priority for the plurality of wirelessly chargeable devices based on status information for each wirelessly chargeable device from the plurality of chargeable devices; and
program instructions, stored on at least one of the one or more storage media for execution by at least one of the one or more processors via at least one of the one or more memories, to adjust a wireless charging signal pattern for the spatial plan based on the priority for the plurality of wirelessly chargeable devices.

16. The computer system of claim 15, further comprising:
program instructions, stored on at least one of the one or more storage media for execution by at least one of the one or more processors via at least one of the one or more memories, to generate an augmented configuration interface for the wireless charging signal pattern for the spatial plan, wherein the augmented configuration interface allows a user to alter the priority for the plurality of wirelessly chargeable devices.

17. The computer system of claim 16, further comprising:
program instructions, stored on at least one of the one or more storage media for execution by at least one of the one or more processors via at least one of the one or more memories, responsive to receiving, via the augmented configuration interface, a request from the user to alter the priority for the plurality of wirelessly chargeable devices, determine whether the user is authorized to alter the priority for the plurality of wirelessly chargeable devices;
program instructions, stored on at least one of the one or more storage media for execution by at least one of the one or more processors via at least one of the one or more memories, responsive to determining the user is authorized to alter the priority for the plurality of wirelessly chargeable devices, provide, via the augmented configuration interface, control for the wireless charging signal pattern to the user; and
program instructions, stored on at least one of the one or more storage media for execution by at least one of the one or more processors via at least one of the one or more memories, to receive, via the augmented configuration interface, an alteration to the priority for the plurality of wirelessly chargeable devices.

18. The computer program product of claim 17, wherein program instructions, stored on at least one of the one or more storage media, to receive, via the augmented configuration interface, the alteration to the priority for the plurality of wirelessly chargeable devices, further comprises:
program instructions, stored on at least one of the one or more storage media for execution by at least one of the one or more processors via at least one of the one or more memories, to receive via the augmented configuration interface, an input from the user altering a direction of the charge wireless charging signal pattern from a first location of a first wirelessly chargeable device from the plurality to a second location of a second wirelessly chargeable device, wherein altering the direction of the charge wireless charging signal pattern alters the priority for the first wirelessly chargeable device and the second wirelessly chargeable device.

19. The computer system of claim 17, wherein program instructions, stored on at least one of the one or more storage media, to receive, via the augmented configuration interface, the alteration to the priority for the plurality of wirelessly chargeable devices, further comprises:
program instructions, stored on at least one of the one or more storage media for execution by at least one of the one or more processors via at least one of the one or more memories, to receive, via the augmented configuration interface, an input from the user altering a position on a priority list of a first wirelessly chargeable device from the plurality of wirelessly chargeable device.

20. The computer system of claim 15, wherein the wireless charging signal pattern is selected from the group consisting of an infrared signal and a radio frequency signal, for charging each wirelessly chargeable device from the plurality of wirelessly chargeable devices.
